(19) United States
(12) Patent Application Publication
(10) Pub. No.: US 2022/0104560 A1
(43) Pub. Date: Apr. 7, 2022

(54) ANIMAL GROOMING GARMENT

(71) Applicant: Constance Jean Hudson, Woodbridge, VA (US)

(72) Inventor: Constance Jean Hudson, Woodbridge, VA (US)

(21) Appl. No.: 17/449,732

(22) Filed: Oct. 1, 2021

Related U.S. Application Data
(60) Provisional application No. 63/198,177, filed on Oct. 1, 2020.

(51) Int. Cl. A41D 13/008; A41D 31/10; A41D 31/14; A41D 31/26

(52) U.S. Cl. CPC A41D 13/008; A41D 31/26; A41D 31/14; A41D 31/10

(57) ABSTRACT

An animal grooming garment that repels hair-dust-dirt is disclosed. Specifically designed to stop hair-dust-dirt from penetrating to clothes and body. is disclosed. The animal grooming garment eliminates open access points to the groomer's clothes and body. It is not hot, does not restrict movement, is not bulky, can merely be shaken clean (although it is washable). It is easily worn over uniforms (mounted police), clothes, jackets. Can be used for a variety of animals to be clipped and protects show clothes and everyday clothes as well as clothes used for clipping.

### CROSS-REFERENCE TO RELATED APPLICATION

This application claims the benefit of priority of U.S. provisional application No. 63/198,177 filed Oct. 1, 2020, the contents of which are herein incorporated by reference.

### BACKGROUND OF THE INVENTION

The present invention relates to animal grooming, and more particularly to protective garments for grooming animals.

When grooming animals, such as brushing, clipping, or cutting the fur and hair of their bodies, it is desirable for the groomer to maintain their clothing in a clean condition. For example, horsehair is almost impossible to remove from clothes. The stiff hairs have a tendency to penetrate the fibers of the groomer's clothing and impales itself into not only the groomer's external and but also their internal garments (i.e., shirts, pants, bras and underwear). Because the hairs become deeply embedded in the clothing, one can wash an item of clothing used while grooming, 6 times or more, before the hairs come out.

Other methods that have been used to protect clothes have open entry points that allow hair, dust, and dirt to penetrate to the groomer's clothing and onto their skin. These garments can also be very hot. These garments also provide limited mobility for the groomer which makes the task of clipping and grooming more difficult.

Other methods attempted such as wearing rain suits or aprons do not stop the hair from penetrating and are extremely hot and can restrict movement.

As can be seen, there is a need for an improved garment that stops hair-dust-dirt from penetrating an animal groomer's clothes and keeps the groomer's body clean.

### SUMMARY OF THE INVENTION

In one aspect of the present invention, a grooming garment for grooming an animal is disclosed. The grooming garment includes an elongate sheet of a fabric material dimensioned to surround a torso and legs of a user. The elongate sheet of fabric material having a continuous frontal surface and is dimensioned to encircle a body of a user. A first and second free ends terminate along a back of the grooming garment. A neck opening is defined at a top end of the grooming garment, with a first plurality of flat elastic bands encircling the neck opening. A left and a right sleeve extend from a shoulder of the grooming garment and terminate at a wrist opening. A second plurality of flat elastic bands encircle the wrist opening with a snug conforming fit. A back closure with a cooperating fastener is provided to join the first and the second free ends of the back of the grooming garment.

In some embodiments, the neck opening has a neck closure that is defined at a back of the neck opening and is aligned with the first and second free ends. A cooperating neck fastener is disposed at the neck closure and is configured for joining the neck opening snugly about a neck of the user.

In some embodiments, a cooperating back fastener is configured for joining the first and second free ends of the grooming garment about a torso of the user.

In some embodiments, a loop is defined at a waistline of the grooming garment. A belt is dimensioned to encircle a waistline of the user.

In some embodiments, the fabric material is a dirt and water-resistant material. In other embodiments, the fabric material is also an antistatic fabric. In preferred embodiments, the fabric material is a breathable fabric.

Other aspects of the invention include a method of grooming an animal. The method includes donning a grooming garment comprising an elongate sheet of a fabric material dimensioned to surround a torso and legs of a user. The elongate sheet has a continuous frontal surface that is dimensioned to encircle a body of a user. An arm of the user is received in each of a left and a right sleeve extending from a shoulder of the grooming garment and terminating at a wrist opening. A first plurality of flat elastic bands are configured to encircle the wrist opening with a snug conforming fit about a wrist of the user. A first and second free ends of the elongate sheet of fabric material is joined along a back closure of the grooming garment via a cooperating fastener at back closure. A neck closure of a neck opening, defined at a top end of the grooming garment, is joined by a first plurality of flat elastic bands encircling the neck opening.

The method also includes grooming the animal with one or more of a brush and a shears.

The method also includes removing the grooming garment.

These and other features, aspects and advantages of the present invention will become better understood with reference to the following drawings, description and claims.

### BRIEF DESCRIPTION OF THE DRAWINGS

FIG. 1 is a front perspective view of the animal grooming garment in use.

FIG. 2 is a rear elevation view of the invention.

FIG. 3 is a detail elevation view taken along line 3-3 of FIG. 2.

FIG. 4 is a rear perspective view of the animal grooming garment in an open position.

FIG. 5 is a detail perspective view taken along line 5-5 of FIG. 4.

FIG. 6 is rear elevation view of the animal grooming garment, shown with belt 30 in use.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide an improved animal grooming garment that prevents the unwanted infiltration of animal hairs and fur onto a groomer's clothing and body.

The animal grooming garment, hereinafter the Clip Smart garment, was developed because of my frequent need to clip my Irish Sport Horse with Cushing's. The horse's breeding naturally gives the horse a heavier coat than most horses and the Cushing's exaggerates the hair growth and causes him to continually grow his winter coat. Therefore, he must be clipped year-round, averaging every 6-7 weeks.

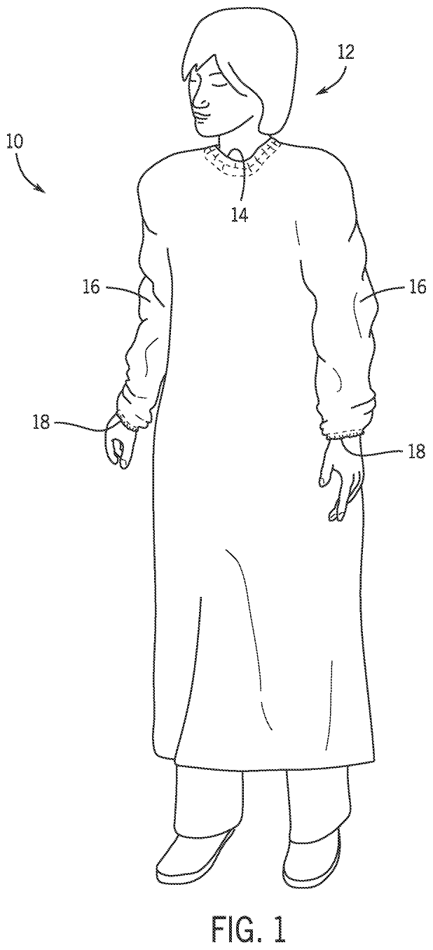

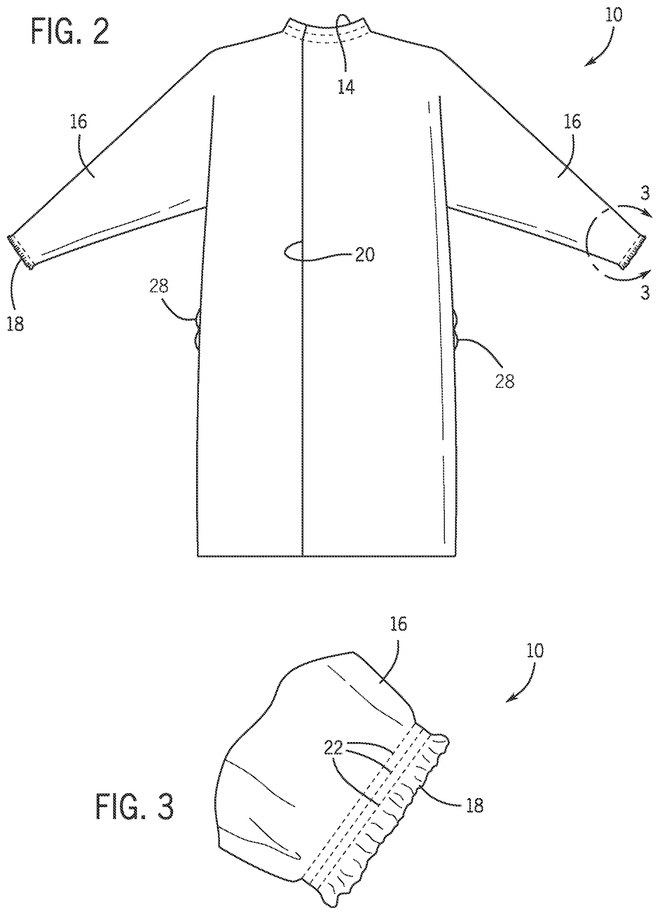

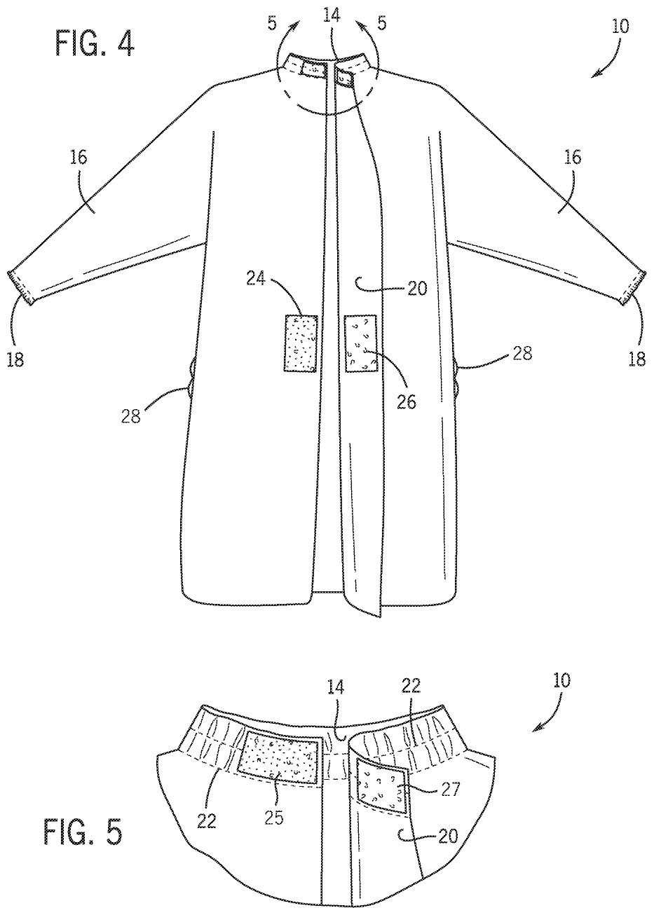

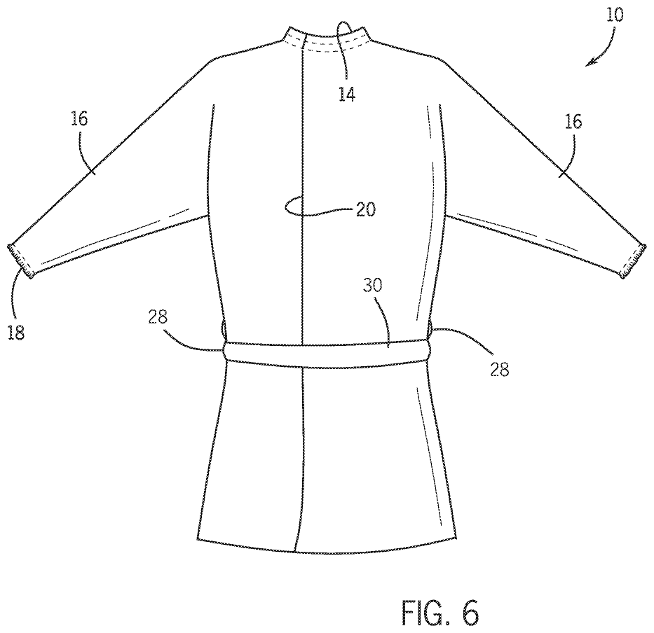

As seen in reference to the drawings of FIGS. 1-6, the Clip Smart garment 10 allows the animal groomer to do partial clippings constantly. All the groomer 12 has to do is put the Clip Smart garment 10 on over whatever they are wearing and clip a part or all of the horse. The groomer 12 can then take the garment 10 off and go about their day, without having to spend 5-6 hours at one time clipping the animal. Using the Clip Smart garment 10, the groomer 12 does not need to take along a change of clothes to wear after completing the clipping.

The Clip Smart garment 10 specifically addresses the problems commonly encountered during clipping/grooming an animal. The Clip Smart garment 10 addresses the issue of open access points by closing the access points at the neck and wrists to the groomer's clothes and body. The neck 14 is closed using double rows of a flat elastic 22 for comfort and a snug fit. A neck closure, includes cooperating fasteners 25, 27, such as a Velcro tab, a hook, a snap, or a button, is provided, preferably at the back of the neckline for a fitted, comfortable closure of a neck opening 14 of the Clip Smart garment 10.

Each sleeve 16 of the garment extends to a wrist length of the groomer's 12 arms and has a wristband closure 18 that are also made with a double row of flat elastic 22 that is dimensioned to fit snuggly around the groomer's wrists, closing those access points to hair and dirt infiltration while grooming the animal.

The Clip Smart garment 10 does not restrict movement and is not bulky or hot. Clip Smart garment 10 is easily cleaned by shaking the hair, dirt and dust off and may also be washed if dirt becomes attached.

The Clip Smart garment 10 is designed to be non-form fitting, easily worn over clothes and coats. The Clip Smart garment 10 also has a hem line that comes to a mid-calf, and is dimensioned to wrap around the entire body of the groomer 12, not allowing access because of uneven hem lines. Because there are no leg openings, the groomer 12 may easily step, squat, or perform other movements of their legs without binding or restriction.

The Clip Smart garment 10 has one or more cooperating fasteners 22, 24, such as Velcro, snaps, hooks, or buttons aligned at a back line 20 of the Clip Smart garment 10 to keep a first and a second free end of the garment 10 closed along the groomer's back. The one or more cooperating fasteners 22, 24 and the neck closure 25, 27 provide for easy donning and removal of the Clip Smart garment 10.

The Clip Smart garment 10 may also equipped with a plurality of belt loops 28, and a belt 30, for those that want a less flowy fit. The belt 30 also makes the Clip Smart garment 10 shorter for a more custom fit, when desired. The Clip Smart garment 10 is easily worn over uniforms (mounted police), clothes, show clothes, jacket, and coats for equestrian riders and groomers.

As indicated, elements of the Clip Smart garment 10 may include the following:

The Clip Smart garment 10 may be formed of a water-repellent, anti-static, breathable, hair-resistant lightweight fabric such as a 100% Nylon, Jig Dye, Hot Calender, DWR (Dirt/Water Resistant) material; thread, flat elastic, Velcro.

An adjustable neck closure 14 made with double flat rows of elastic and Velcro

The neck 25, 27 and a back closure 24, 26 are preferably made with extra wide Velcro patches for quick and easy on and off. The sleeve closures 18 are made with double flat rows of elastic 22. The belt 30 and belt loops 28 are made from same fabric as the body of the garment 10. Two inside side pockets on the seams for small items such as clipper oil.

The material is cut to the garment sizes specifications for the groomer. Using thread and a surging sewing machine the flat elastic is sewn into double rows to create the neck closure. Normal width Velcro is sewn to the ends of the neck closure to provide a custom fit.

Using flat elastic 22 and thread the sleeve closures 18 are made with a double row of elastic 22 for a snug fit.

Using thread and extra wide Velcro that is sewn directly onto the fabric in two places on the opening of the back 20 of the garment and the neck 14 creates the two back closures.

Belt 20 may be created by sewing long strips of the garment fabric together. Belt loops 28 are provided on the sides of the Clip Smart garment 10.

The Clip Smart garment 10 can be used for clipping and grooming a variety of animals giving the same protection to show clothes as well as everyday clothing.

It should be understood, of course, that the foregoing relates to exemplary embodiments of the invention and that modifications may be made without departing from the spirit and scope of the invention as set forth in the following claims.

What is claimed is:

1. A grooming garment, comprising:
an elongate sheet of a fabric material dimensioned to surround a torso and legs of a user, the elongate sheet having a continuous frontal surface and is dimensioned to encircle a body of a user, and a first and second free ends that terminate along a back of the grooming garment;
a neck opening defined at a top end of the grooming garment, a first plurality of flat elastic bands encircling the neck opening;
a left and a right sleeve extend from a shoulder of the grooming garment and terminate at a wrist opening, a second plurality of flat elastic bands encircle the wrist opening with a snug conforming fit; and
a back closure having a cooperating fastener to join the first and the second free ends of the back of the grooming garment.

2. The grooming garment of claim 1, wherein the neck opening has a neck closure defined at a back of the neck opening and aligned with the first and second free ends.

3. The grooming garment of claim 2, further comprising:
a cooperating neck fastener disposed at the neck closure configured for joining the neck opening snugly about a neck of the user.

4. The grooming garment of claim 3, further comprising:
a cooperating back fastener configured for joining the first and second free ends of the grooming garment about a torso of the user.

5. The grooming garment of claim 4, further comprising:
a loop defined at a waistline of the grooming garment; and
a belt dimensioned to encircle a waistline of the user.

6. The grooming garment of claim 1, wherein the fabric material is a dirt and water-resistant material.

7. The grooming garment of claim 6, wherein the fabric material is an antistatic fabric.

8. The grooming garment of claim 7, wherein the fabric material is a breathable fabric.

9. A method of grooming an animal, comprising:
donning a grooming garment comprising an elongate sheet of a fabric material dimensioned to surround a torso and legs of a user, the elongate sheet having a continuous frontal surface that is dimensioned to encircle a body of a user,
receiving an arm of the user in each of a left and a right sleeve extending from a shoulder of the grooming garment and terminating at a wrist opening, with a first plurality of flat elastic bands configured to encircle the wrist opening with a snug conforming fit about a wrist of the user;
joining a first and second free ends of the elongate sheet of fabric material along a back closure of the grooming garment via a cooperating fastener at back closure;
joining a neck closure of a neck opening defined at a top end of the grooming garment by a first plurality of flat elastic bands encircling the neck opening.

10. The method of claim 9, further comprising:
grooming the animal with one or more of a brush and a shears.

11. The method of claim 10, further comprising:
removing the grooming garment.
